(19) United States
(12) Patent Application Publication
(10) Pub. No.: US 2026/0146723 A1
(43) Pub. Date: May 28, 2026

(54) LAMP FOR A VEHICLE AND A VEHICLE INCLUDING THE SAME

(71) Applicants: HYUNDAI MOTOR COMPANY, Seoul (KR); KIA CORPORATION, Seoul (KR); ZKW GROUP GMBH, Wieselburg (AT)

(72) Inventors: Hyeong Seon Kim, Hwaseong-si (KR); Chang Hoon Choi, Hwaseong-si (KR); Nina Brauner, Altlengbach (AT); Dominic Gottsmann, Waasen (AT); Mong Kwon Jung, Gimpo-si (KR); Nam Seok Oh, Goyang-si (KR)

(73) Assignees: HYUNDAI MOTOR COMPANY, Seoul (KR); KIA CORPORATION, Seoul (KR); ZKW GROUP GMBH, Wieselburg (AT)

(21) Appl. No.: 19/098,405

(22) Filed: Apr. 2, 2025

(30) Foreign Application Priority Data
Nov. 22, 2024 (KR) 10-2024-0168608

(51) Int. Cl. F21S 41/25; F21S 41/143; F21S 41/151

(52) U.S. Cl. CPC F21S 41/25; F21S 41/143; F21S 41/151

(57) ABSTRACT

A lamp for a vehicle includes a light source portion including a plurality of light source elements and an inner lens portion including a plurality of lenses through which light from the plurality of light source elements passes. The plurality of lenses include a lens array having a plurality of light-collecting lenses. The plurality of light-collecting lenses includes at least one asymmetrical sub-lens having an asymmetrical shape.

### CROSS-REFERENCE TO RELATED APPLICATION(S)

This application claims the benefit of and priority to Korean Patent Application No. 10-2024-0168608 filed on Nov. 22, 2024, in the Korean Intellectual Property Office, the disclosure of which is incorporated herein by reference in its entirety.

### BACKGROUND

### 1. Field

The present disclosure relates to a lamp for a vehicle, and to a vehicle including the same.

### 2. Description of Related Art

Recently, a headlamp system of a vehicle may include an intelligent front-lighting system (IFS) function exceeding functionality of a conventional headlamp that only turns such a headlamp system on or off, and emits light except in regions corresponding to an oncoming vehicle or a preceding vehicle when detecting the oncoming vehicle or the preceding vehicle in front of a vehicle while the headlamp system is turned on, creating matrix-like beam patterns.

Such an IFS function may be a function that recognizes a preceding vehicle or an oncoming vehicle through a camera when driving at night, and partially or completely turns off portions of driving beams shining on the preceding vehicle and the oncoming vehicle, based thereon, to prevent glare for other drivers in other vehicles and to maintain lighting of other portions, thereby improving visibility for a driver travelling in a vehicle.

The statements in this Background section merely provide background information related to the present disclosure and may not constitute prior art.

### SUMMARY

A headlamp applied to a vehicle has recently trended toward an overall compact and slim design, so developing and securing optical system technology for implementing slimness in headlamps to which the IFS function is applied may also be required.

An aspect of the present disclosure is to provide a lamp for a vehicle to which an optical system for implementing a slim IFS is applied and to provide a vehicle including the same.

According to an embodiment of the present disclosure, a lamp for a vehicle includes: a light source portion including a plurality of light source elements; and an inner lens portion including a plurality of lenses through which light from the plurality of light source elements passes. The plurality of lenses includes a lens array having a plurality of light-collecting lenses. The plurality of light-collecting lenses includes at least one asymmetrical sub-lens having an asymmetrical shape. The at least one asymmetrical sub-lens is provided on a side portion of the lens array.

In an embodiment, the plurality of light-collecting lenses may include a symmetrical sub-lens portion including a plurality of symmetrical sub-lenses. The at least one asymmetrical sub-lens may be disposed on a side of the symmetrical sub-lens portion.

In an embodiment, each of the plurality of symmetrical sub-lenses may have a shape symmetrical about a first virtual straight line connecting a vertex of an incident surface and a vertex of an exit surface, and may have a center overlapping the first virtual straight line.

In an embodiment, among the plurality of light source elements, a light source element corresponding to the plurality of symmetrical sub-lenses may be disposed such that the first virtual straight line passes through a center of the light source element corresponding to the plurality of symmetrical sub-lenses.

In an embodiment, the at least one asymmetrical sub-lens may have a shape asymmetrical at both sides in a horizontal direction in which the plurality of light-collecting lenses is disposed. The at least one asymmetrical sub-lens may have a shape asymmetrical based on a second virtual straight line connecting a vertex of an incident surface and a vertex of an exit surface. The at least one asymmetrical sub-lens may have a center offset from the second virtual straight line.

In an embodiment, among the plurality of light source elements, a light source element corresponding to the at least one asymmetrical sub-lens may be disposed such that the second virtual straight line passes through a center of the light source element corresponding to the at least one asymmetrical sub-lens.

In an embodiment, each of the plurality of symmetrical sub-lenses may be formed to have the same size, and the at least one asymmetrical sub-lens may be formed to have a size, greater than the size of each of the plurality of symmetrical sub-lenses.

In an embodiment, the at least one asymmetrical sub-lens may include first asymmetrical sub-lenses each connected to each of both sides of the symmetrical sub-lens portion, and second asymmetrical sub-lenses each connected to each of the first asymmetrical sub-lenses.

In an embodiment, each of the second asymmetrical sub-lenses may be formed to have a size, greater than a size of each of the first asymmetrical sub-lenses.

In an embodiment, each the second asymmetrical sub-lens may have an optical power less than an optical power of each the first asymmetrical sub-lens and the first asymmetrical sub-lens may have an optical power less than an optical power of each of the plurality of symmetrical sub-lenses.

In an embodiment, the second asymmetrical sub-lenses of a greater size are connected on a respective outer side of the first asymmetrical sub-lenses of a smaller size.

In an embodiment, the lamp may further include an outer lens portion disposed in front of the inner lens portion, and a bezel to which the outer lens portion and the light source portion are coupled. The light source portion may further include a substrate coupled to the bezel. The plurality of light source elements may be disposed on a front surface of the substrate.

In an embodiment, the inner lens portion may be coupled to the front surface of the substrate, such that the plurality of lenses faces the plurality of light source elements.

In an embodiment, the lamp may further include a bulkhead member disposed between the outer lens portion and the inner lens portion, wherein the bulkhead member may separate and divide a space between the inner lens portion and the outer lens portion into two or more spaces.

In an embodiment, the inner lens portion may include a first inner lens portion and a second inner lens portion disposed with a predetermined gap therebetween, and the lens array may include a first lens array provided in the first inner lens portion, and a second lens array provided in the second inner lens portion.

In an embodiment, the bulkhead member may include a central bulkhead inserted into the gap between the first inner lens portion and the second inner lens portion to block a space between the first lens array and the second lens array.

In an embodiment, the first lens array and the second lens array may have the same shape, and the first inner lens portion and the second inner lens portion may be symmetrical with respect to the gap.

In an embodiment, the plurality of lenses may further include a first lens provided in the first inner lens portion and spaced apart from the first lens array to face one side (i.e., spaced apart from one side of the first lens array), and a second lens provided in the second inner lens portion and spaced apart from the second lens array to face one side (i.e., spaced apart from one side of the second lens array).

According to an embodiment of the present disclosure, a lamp for a vehicle includes a light source portion including a plurality of light source elements spaced apart at equal intervals, and an inner lens portion including a plurality of lenses through which light from the plurality of light source elements passes. The plurality of lenses includes a lens array having a plurality of light-collecting lenses. The plurality of light-collecting lenses include a plurality of symmetrical sub-lenses having a symmetrical shape and at least one asymmetrical sub-lens having an asymmetrical shape provided on a side portion of a symmetrical sub-lens portion including the plurality of symmetrical sub-lenses. An optical center of each of the plurality of light-collecting lenses is formed to be aligned with a center of each of the plurality of light source elements.

In an embodiment, the optical center may overlap a virtual straight line connecting a vertex of an incident surface and a vertex of an exit surface of each of the plurality of light-collecting lenses, and the asymmetrical sub-lens may have a shape asymmetrical at both sides, based on the virtual straight line.

According to an embodiment of the present disclosure, a vehicle includes a lamp. The lamp includes a light source portion including a plurality of light source elements, and an inner lens portion including a plurality of lenses through which light from the plurality of light source elements passes. The plurality of lenses includes a lens array having a structure in which a plurality of sub-lenses is connected, and disposed to face at least a portion of the plurality of light source elements. At least one asymmetrical sub-lens having an asymmetrical shape is provided on a side portion of the lens array.

In an embodiment, the plurality of sub-lenses may include a symmetrical sub-lens portion including a plurality of symmetrical sub-lenses forming a center of the lens array. The at least one asymmetrical sub-lens may be disposed at both sides of the symmetrical sub-lens portion, respectively.

### BRIEF DESCRIPTION OF DRAWINGS

The above and other aspects, features, and advantages of the present disclosure should be more clearly understood from the following detailed description, taken in conjunction with the accompanying drawings.

FIG. 1 is a perspective view of a lamp for a vehicle according to an embodiment of the present disclosure.

FIG. 2 is an exploded perspective view of a lamp for a vehicle according to an embodiment of the present disclosure.

FIG. 3 is a front view of a lamp for a vehicle according to an embodiment of the present disclosure.

FIG. 4 is a cross-sectional view of a lamp for a vehicle according to an embodiment of the present disclosure.

FIG. 5 is a view illustrating a light source portion and an inner lens portion of a lamp for a vehicle according to an embodiment of the present disclosure.

FIG. 6 is a view illustrating a lens array of an inner lens portion according to an embodiment of the present disclosure.

FIG. 7 is a view illustrating a lens array of an inner lens portion according to an embodiment of the present disclosure.

FIGS. 8A and 8B are views illustrating a layout relationship between a lens array and a light source element array of a lamp for a vehicle according to an embodiment of the present disclosure.

FIG. 9 is a view illustrating a layout relationship between a lens array and a light source element array of a lamp for a vehicle according to an embodiment of the present disclosure.

The drawings described herein are for illustration purposes only and are not intended to limit the scope of the present disclosure in any way.

### DETAILED DESCRIPTION

Since embodiments of the present disclosure may have various changes, and may have various embodiments, specific embodiments are illustrated in the drawings and described in detail. However, this is not intended to limit the present disclosure to specific embodiments, it should be understood to include all modifications, equivalents, and substitutes included in the spirit and scope of the present disclosure.

Terms such as first, second, and the like may be used to describe various elements, but the elements should not be limited by the terms. The above terms may be used only for the purpose of distinguishing one component from another. For example, without departing from the scope of the present disclosure, a first component may be referred to as a second component, and similarly, a second component may also be referred to as a first component. The term “and/or” may include a combination of a plurality of related listed items or any of a plurality of related listed items.

The terms used in the present application may be only used to describe specific embodiments, and may not be intended to limit the present disclosure. The singular expression may include the plural expression unless the context clearly dictates otherwise. In the present application, terms such as “comprise,” “include,” “have,” and the like are intended to designate that a feature, a number, an operation, an operation, a component, a part, or a combination thereof described in the specification exists, but it should be understood that the existence or addition of one or more other features, numbers, steps, operations, components, parts, or combinations thereof are excluded in advance.

Unless defined otherwise, all terms used herein, including technical or scientific terms, have the same meaning as that commonly understood by one of ordinary skill in the art to which the present disclosure belongs. Terms such as those defined in a commonly used dictionary should be interpreted as having a meaning consistent with the meaning in the context of the related art, and should not be interpreted in an ideal or excessively formal meaning unless explicitly defined in the present disclosure.

In this specification, a vehicle (including an electric vehicle) means various vehicles that move a transport object such as a person, an animal, an object, or the like from a starting point to a destination. Such vehicles are not limited to vehicles that run on roads or tracks.

Hereinafter, embodiments of the present disclosure are described with reference to the drawings.

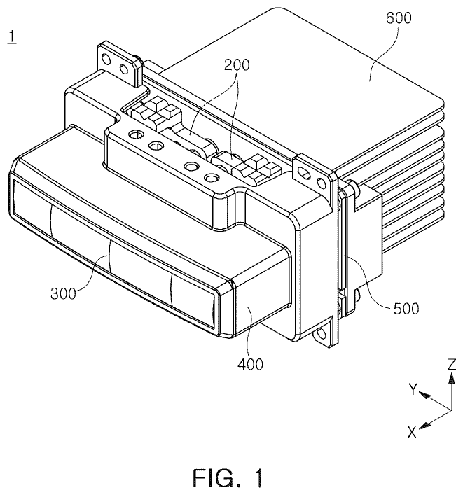

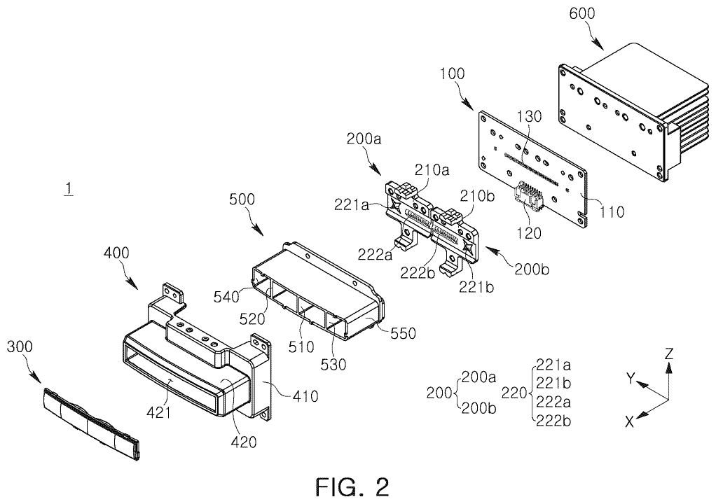

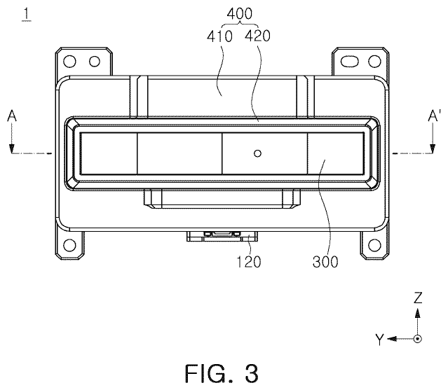

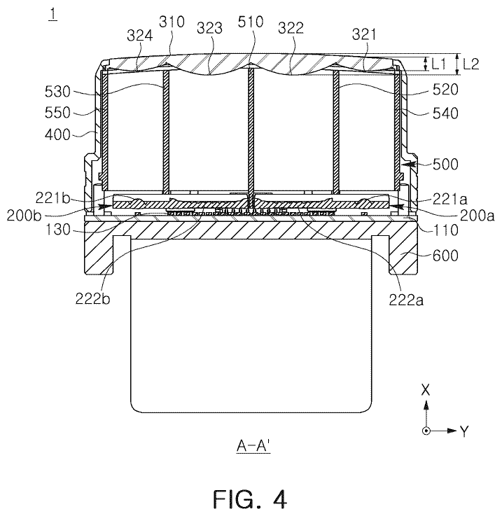

FIG. 1 is a perspective view of a lamp for a vehicle according to an embodiment of the present disclosure. FIG. 2 is an exploded perspective view of a lamp for a vehicle according to an embodiment of the present disclosure. FIG. 3 is a front view of a lamp for a vehicle according to an embodiment of the present disclosure. FIG. 4 is a cross-sectional view of a lamp for a vehicle according to an embodiment of the present disclosure.

FIG. 2 illustrates an exploded state of a lamp 1 for a vehicle illustrated in FIG. 1. FIG. 3 illustrates a front view of a lamp 1 for a vehicle illustrated in FIG. 1. FIG. 4 illustrates a cross-section of a lamp 1 for a vehicle illustrated in FIG. 3 along line A-A'.

Referring to FIGS. 1-4 , a lamp 1 for a vehicle according to an embodiment may include a light source portion 100, an inner lens portion 200, an outer lens portion 300, a bezel 400, a bulkhead member 500, and a heat sink 600.

A lamp may be headlight unit or headlight device of vehicle.

The light source portion 100 may generate and emit light toward the inner lens portion 200 and the outer lens portion 300. The light source portion 100 may include a plurality of light source elements 130 that emit light, and a substrate 110 on which the plurality of light source elements 130 are disposed.

The plurality of light source elements 130 may be electrically connected to the substrate 110, and a connector 120 may be provided on the substrate 110. The plurality of light source elements 130 may be disposed in a side-by-side manner on the substrate 110. The plurality of light source elements 130 may be a light-emitting diode (LED), but a type of a light source element is not limited thereto. For example, the plurality of light source elements 130 may be configured as a matrix beam LED.

In the substrate 110, the plurality of light source elements 130 may be disposed on a front surface (e.g., surface facing a +X-axis direction), and the heat sink 600 may be disposed on a back surface (e.g., surface facing a −X-axis direction) opposing the front surface. For example, the plurality of light source elements 130 may be mounted on the front surface of the substrate 110 to be electrically connected to the substrate 110, and the heat sink 600 may be coupled to the substrate 110 through a fastening means (not illustrated). The plurality of light source elements 130 may be disposed on the front surface of the substrate 110 in a horizontal direction (e.g., Y-axis direction). The substrate 110 may be a printed circuit board (PCB), but is not limited thereto.

The substrate 110 may be coupled to the bezel 400. For example, the substrate 110 may be coupled and fixed to the substrate 110 through the fastening means. According to various embodiments, the fastening means may be fixed to the bezel 400 by penetrating the heat sink 600 and the substrate 110, and fastening the heat sink 600 and the substrate 110 to the bezel 400. A method by which the heat sink 600 and the substrate 110 are coupled to the bezel 400 is not particularly limited, and may be implemented in various forms.

Light emitted from the plurality of light source elements 130 of the light source portion 100 may be controlled by the inner lens portion 200 and the outer lens portion 300, located in front. The inner lens portion 200 located in front of the plurality of light source elements 130 may form a matrix-like beam pattern, and light formed by the inner lens portion 200 is refracted by the outer lens portion 300 so that these matrix-like beam pattern may be collimated or diffused.

The inner lens portion 200 may be located in front of the light source portion 100. The inner lens portion 200 may be located in front of the light source portion 100 such light emitted from the plurality of light source elements 130 may be incident. The inner lens portion 200 may be located between the bulkhead member 500 and the light source portion 100. The inner lens portion 200 may be coupled to the bezel 400.

The inner lens portion 200 may be referred to as a primary lens portion, a primary optical device, or a primary light collection control lens, through which light emitted from the plurality of light source elements 130 first passes. For example, the inner lens portion 200 may perform light collection control in horizontal and vertical directions. The inner lens portion 200 may be formed of a transparent material. The inner lens portion 200 may have the same material as a whole. The inner lens portion 200 may have properties of a collimator optics.

The inner lens portion 200 may include a plurality of lenses 220 corresponding to each of the plurality of light source elements 130. The plurality of lenses 220 and the plurality of light source elements 130 may be aligned to face each other in a direction, perpendicular to the front surface of the substrate 110 (e.g., X-axis direction). For example, the plurality of lenses 220 may be provided in a number, equal to the number of the plurality of light source elements 130, and may be matched in a ratio of 1:1, with the plurality of light source elements 130. For example, the plurality of light source elements 130 and the plurality of lenses 220 may be configured such that one light source element is assigned to one lens, such that light emitted from a specific light source element disposed to face each of the lenses, among the plurality of light source elements 130, may be incident on each of the plurality of lenses 220.

The plurality of lenses 220 may include a first lens 221a, a second lens 221b, a first lens array 222a, and a second lens array 222b. For example, the first lens 221a, the first lens array 222a, the second lens array 222b, and the second lens 221b may be disposed in a horizontal direction corresponding to arrangement of the plurality of light source elements 130. The first lens 221a may be spaced apart from the first lens array 222a to face one side (e.g., +Y-axis direction), and the second lens 221b may be spaced apart from the second lens array 222b to face the other side (e.g., −Y-axis direction). The first lens array 222a and the second lens array 222b may be spaced apart by a predetermined interval in a horizontal direction.

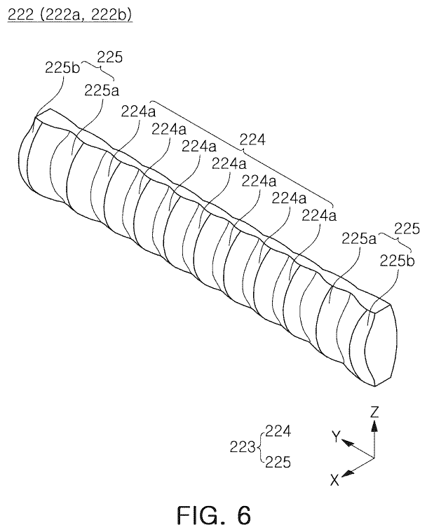

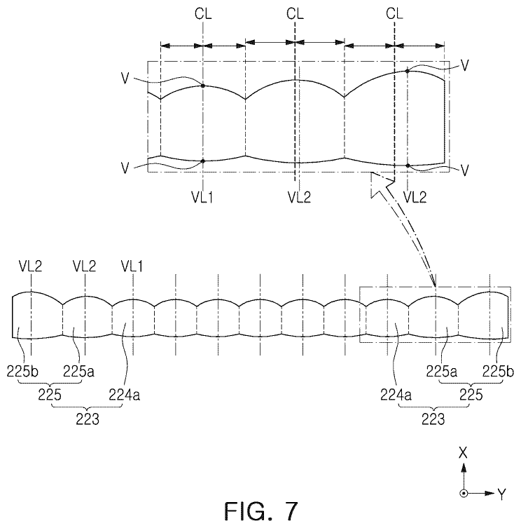

The first lens array 222a and the second lens array 222b may be formed in a configuration in which a plurality of light-collecting lenses disposed in a horizontal direction are integrally connected (e.g., see FIGS. 6 and 7). For example, the plurality of light-collecting lenses may be referred to as a plurality of sub-lenses 223. The first lens array 222a and the second lens array 222b may be connected in a configuration in which there is no gap between the plurality of sub-lenses. One light source element may be assigned to each of the plurality of sub-lenses constituting the first lens array 222a and the second lens array 222b, and light emitted from a specific light source element disposed to face it may be incident on one of the plurality of sub-lenses.

The first lens 221a, the second lens 221b, the plurality of sub-lenses of the first lens array 222a and the plurality of sub-lenses of the second lens array 222b, provided in the inner lens portion 200, may be formed in a double convex lens shape in which both surfaces are convex. In this case, the both surfaces may include an incident surface and an exit surface, and the incident surface may be a surface facing the plurality of light source elements 130, and the exit surface may be a surface opposing the incident surface and facing the outer lens portion 300. The plurality of sub-lenses are not necessarily limited to a shape in which both surfaces are convex, and may include various lenses capable of performing a light-collecting function.

A lamp 1 according to an embodiment of the present disclosure, may have a structure in which at least one sub-lens located at an edge, among a plurality of sub-lenses included in the first lens array 222a and the second lens array 222b of the inner lens portion 200, has an asymmetrical shape and a position facing the light source element 130 is offset from a sub-lens center. A structure or a shape of such a lens array (222a and 222b) is described in detail below with reference to FIGS. 6-8 .

The inner lens portion 200 may be composed of two components having a symmetrical shape. The inner lens portion 200 may include a first inner lens portion 200a and a second inner lens portion 200b, and the first inner lens portion 200a and the second inner lens portion 200b may be respectively provided with a portion of the plurality of lenses 220. For example, the first inner lens portion 200a may be provided with the first lens 221a and the first lens array 222a, and the second inner lens portion 200b may be provided with the second lens 221b and the second lens array 222b.

The first inner lens portion 200a and the second inner lens portion 200b may be coupled to the substrate 110 while being spaced apart by a predetermined interval, and thus, the predetermined interval may be formed between the first lens array 222a and the second lens array 222b. The first inner lens portion 200a and the second inner lens portion 200b may be symmetrical left and right, based on a symmetry axis, parallel to a height direction (e.g., Z-axis direction) of the lamp 1. In this case, the symmetry axis may be located to overlap a gap between the first inner lens portion 200a and the second inner lens portion 200b.

The inner lens portion 200 may be formed to have a plate shape in which the plurality of lenses 220 are formed or provided in a certain region, and may be coupled to the substrate 110 of the light source portion 100. The inner lens portion 200 may include a base portion (210a and 210b) that may be coupled to the substrate 110, and may be formed in a configuration in which the plurality of lenses 220 are formed in a portion of the base portion (210a and 210b).

The first inner lens portion 200a may be formed in a configuration in which the first lens 221a and the first lens array 222a are formed in a first base portion 210a, and the second inner lens portion 200b may be formed in a configuration in which the second lens 221b and the second lens array 222b are formed in a second base portion 210b. For example, the inner lens portion 200 may be formed in a configuration in which the plurality of lenses 220 are formed by processing (e.g., injection molding, cutting, sawing, and the like) a portion of the base portion (210a and 210b) that may be a transparent material.

According to an embodiment illustrated, the lamp 1 may have a structure in which the first inner lens portion 200a and the second inner lens portion 200b are separated from each other and a central bulkhead 510 of the bulkhead member 500 is disposed in a gap therebetween, to separate and divide the first lens array 222a and the second lens array 222b, but is illustrative, and a lamp 1 according to the present disclosure is not limited to those illustrated.

According to various embodiments, the inner lens portion 200 may be configured as a single component by integrally connecting the first inner lens portion 200a and the second inner lens portion 200b. For example, the inner lens portion 200 may be configured as a structure in which the first base portion 210a of the first inner lens portion 200a and the second base portion 210b of the second inner lens portion 200b are connected to each other, a groove (not illustrated) having a predetermined depth is provided between the first lens array 222a and the second lens array 222b to separate the first lens array 222a and the second lens array 222b, and the central bulkhead 510 of the bulkhead member 500 is inserted into the groove to separate and divide the first lens array 222a and the second lens array 222b.

The outer lens portion 300 may be coupled to the bezel 400 to be located in front of the inner lens portion 200. The outer lens portion 300 may receive light emitted from the plurality of light source elements 130 and passed through the inner lens portion 200, to emit the light to an outside of the lamp 1. The outer lens portion 300 may be formed of a transparent material. The outer lens portion 300 may have properties of a cylinder optics.

The outer lens portion 300 may be referred to as a secondary lens portion, a secondary optical device, or a secondary light collection control lens, through which light that first passed through the inner lens portion 200 passes secondarily. For example, the outer lens portion 300 may perform horizontal light collection control.

A lamp 1 according to an embodiment of the present disclosure may be designed such that at least one light distribution (or light pattern) is generated by the outer lens portion 300 by projecting light emitted from a plurality of light source elements 130 matched (or assigned) to each of the plurality of lenses 220 of the inner lens portion 200 toward the outer lens portion 300. For example, light emitted from a plurality of light source elements 130 may form individual light patterns(e.g., matrix-like beam pattern) by passing through the plurality of lenses 220 and the outer lens portion 300, and an overall light distribution to be implemented by the lamp 1, according to the present disclosure, may be formed by overlapping the individual light patterns.

The outer lens portion 300 may be coupled to the bezel 400 such that an exit surface 310 may be exposed to the outside of the lamp 1, and an incident surface 320 of the outer lens portion 300 may face the inner lens portion 200 in the bezel 400. The outer lens portion 300 may be formed such that the exit surface 310 has a shape of a convex surface (e.g., single convex surface) having a predetermined curvature, and the incident surface 320 has a shape of a plurality of convex surfaces connected at least in portion with different degrees of convexity.

The incident surface 320 of the outer lens portion 300 may include a first incident surface 321 facing the first lens 221a of the inner lens portion 200, a second incident surface 322 facing the first lens array 222a of the inner lens portion 200, a third incident surface 323 facing the second lens array 222b of the inner lens portion 200, and a fourth incident surface 324 facing the second lens 221b of the inner lens portion 200. Each of the first incident surface 321 and the second incident surface 322 may have a convex shape toward the inner lens portion 200, and may be connected to each other to be integrated. For example, the outer lens portion 300 may be implemented as a single component having the exit surface 310 having a flat shape and first to fourth incident surfaces 321 to 324 having different degrees of convex protrusion.

The first incident surface 321 and the fourth incident surface 324 may be convexly protruded from the exit surface 310 by a first length L1, and the second incident surface 322 and the third incident surface 323 may be convexly protruded from the exit surface 310 by a second length L2, greater than the first length L1. For example, a distance in front and back directions (e.g., X-axis direction) between vertices of the first and fourth incident surfaces 321 and 324 and the exit surface 310 may be the first length L1, and a distance in the front-back direction between vertices of the second and third incident surfaces 322 and 323 and the exit surface 310 may be the second length L2, greater than the first length L1.

Each of the first to fourth incident surfaces 321 to 324 may face each of the plurality of lenses 220 of the inner lens portion 200 in a space separated and divided by the bulkhead member 500. The first incident surface 321 may face the first lens 221a in a space between a first side wall 540 and a first bulkhead 520. The second incident surface 322 may face the first lens array 222a in a space between the first bulkhead 520 and the central bulkhead 510. The third incident surface 323 may face the second lens array 222b in a space between the central bulkhead 510 and a second bulkhead 530. The fourth incident surface 324 may face the second lens 221b in a space between the second bulkhead 530 and a second side wall 550.

The first incident surface 321 to the fourth incident surface 324 of the outer lens portion 300 may be disposed to face a plurality of lenses 220, corresponding thereto, in a space separated by the bulkhead member 500, such that only light passing through a plurality of lenses 220, corresponding thereto, may be incident. For example, light passing through the first lens 221a may be restricted from being incident on the second incident surface 322 to the fourth incident surface 324 by the first side wall 540, and similarly, light passing through the first lens array 222a may be restricted from being incident on the first incident surface 321 by the first side wall 540, and may be restricted from being incident on the third incident surface 323 and the fourth incident surface 324 by the central bulkhead 510.

The bezel 400 may form at least a portion of an exterior of the lamp 1, and at least a portion of other components of the lamp 1 may be coupled thereto. For example, the heat sink 600, the light source portion 100, the bulkhead member 500, and the outer lens portion 300 may be coupled to the bezel 400.

The bezel 400 may include a frame portion 410 to which the substrate 110 and the heat sink 600 are coupled, and an extension portion 420 extending from the frame portion 410 in a forward direction and to which the outer lens portion 300 is coupled.

The extension portion 420 may have an opening 421 formed in a shape corresponding to the outer lens portion 300 in a forward direction such that the outer lens portion 300 is coupled thereto. At least a portion of the bulkhead member 500 may be inserted into the extension portion 420. For example, the extension portion 420 may have a predetermined accommodating space to accommodate at least a portion of the bulkhead member 500.

The bulkhead member 500 may be disposed between the outer lens portion 300 and the inner lens portion 200, and may guide a path of light passing through the inner lens portion 200. The bulkhead member 500 may be formed of a material that does not allow light to pass through, thereby limiting a path of light movement to a predetermined range.

At least a portion of the bulkhead member 500 may be inserted into the bezel 400 (particularly, extension portion 420). In the bulkhead member 500, the central bulkhead 510, the first bulkhead 520, and the second bulkhead 530 may be provided at predetermined intervals. For example, the bulkhead member 500 may include the first side wall 540 and the second side wall 550, forming a lateral appearance, and the first bulkhead 520, the central bulkhead 510, and the second bulkhead 530 may be disposed between the first side wall 540 and the second side wall 550.

An internal space of the bulkhead member 500 may be separated and divided into four spaces by the first bulkhead 520, the central bulkhead 510, and the second bulkhead 530. The first bulkhead 520, the central bulkhead 510, and the second bulkhead 530 may extend in forward and backward directions (e.g., X-axis direction) by a predetermined length, thereby limiting light passing through a portion of the inner lens portion 200 from being incident on a portion, other than a portion of the outer lens portion 300, corresponding thereto.

The central bulkhead 510 of the bulkhead member 500 may extend such that at least a portion thereof is inserted between the first lens array 222a and the second lens array 222b. The first lens array 222a and the second lens array 222b may be separated by the central bulkhead 510, such that movement of light between the first lens array 222a and the second lens array 222b may be blocked. For example, it can be understood that the central bulkhead 510 is disposed in a space between the first inner lens portion 200a and the second inner lens portion 200b.

The heat sink 600 may be a heat dissipation device, and may be formed of a metal material having high heat dissipation efficiency, such as aluminum, and may be bolted to the substrate 110 and/or the bezel 400 to contact a back surface of the substrate 110 of the light source portion 100.

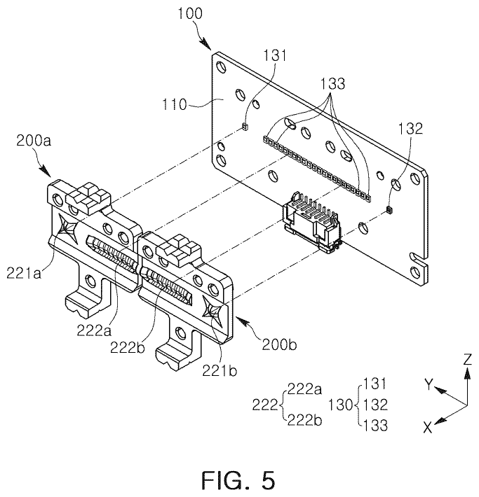

FIG. 5 is a view illustrating a light source portion and an inner lens portion of a lamp for a vehicle according to an embodiment of the present disclosure. FIG. 6 is a view illustrating a lens array of an inner lens portion according to an embodiment of the present disclosure. FIG. 7 is a view illustrating a lens array of an inner lens portion according to an embodiment of the present disclosure.

FIG. 5 is a view illustrating an enlarged view of a light source portion 100 and an inner lens portion 200 in an exploded perspective view of the lamp 1 illustrated in FIG. 2.

FIG. 6 and FIG. 7 are views illustrating an enlarged view of the lens array 222 illustrated in FIG. 5, FIG. 6 is a perspective view of the lens array 222 and FIG. 7 is a plan view of the lens array 222. For example, a first lens array 222a and a second lens array 222b may have the same shape, and it can be understood that the lens array 222 illustrated in FIG. 6 and FIG. 7 include the first lens array 222a and the second lens array 222b.

FIGS. 5-7 are views specifically illustrating a structure and/or a shape of a lens array 222 provided in an inner lens portion 200 of a lamp 1 for a vehicle, as described with reference to FIGS. 1-4 above, and thus, any redundant description has been omitted hereinafter.

Referring to FIG. 5, a lamp 1 for a vehicle according to an embodiment may include a light source portion 100 having a plurality of light source elements 130, and an inner lens portion 200 disposed in front of the light source portion 100 and having a plurality of lenses 220 corresponding to each of the plurality of light source elements 130.

The plurality of lenses 220 may include a first lens 221a, a first lens array 222a, a second lens 221b, and a second lens array 222b. The first lens 221a and the first lens array 222a may be provided in a first inner lens portion 200a, and the second lens 221b and the second lens array 222b may be provided in a second inner lens portion 200b.

The plurality of light source elements 130 may include a light source element array 133 corresponding to the first lens array 222a and the second lens array 222b, a first light source element 131 corresponding to the first lens 221a, and a second light source element 132 corresponding to the second lens 221b. The light source element array 133 may include light source elements disposed to be spaced at a predetermined interval. The first light source element 131 may be spaced apart from the light source element array 133 at a predetermined interval, to face one side, and the second light source element 132 may be spaced apart from the light source element array 133 at a predetermined interval, to face the other side.

The light source elements provided in the light source element array 133 may be respectively matched with a plurality of sub-lenses 223 provided in the first lens array 222 a and the second lens array 222b, and the first light source element 131 may be matched with the first lens 221a, and the second light source element 132 may be matched with the second lens 221b. For example, light emitted from the first light source element 131 and the second light source element 132 may pass through the first lens 221a and the second lens 221b, respectively, and may be incident on an outer lens portion 300. In addition, light emitted from the light source elements provided in the light source element array 133 may pass through a plurality of sub-lenses 223 matched (or assigned) 1:1 to each other, and may be incident on the outer lens portion 300.

The first light source element 131 and the second light source element 132 may have a larger amount of light than a light source elements provided in the light source element array 133. The first lens 221a and the second lens 221b may have a larger size than the plurality of sub-lenses 223 provided in the first lens array 222a and the second lens array 222b. The first light source element 131 and the second light source element 132 may be spaced apart from the light source element array 133 by the same distance, and the distance to be spaced apart from the light source element array 133 may be greater than a distance of which the light source elements provided in the light source element array 133 are spaced apart from each other.

According to an embodiment illustrated, the light source portion 100 may include a total of twenty four elements, including one first light source element 131, one second light source element 132, and a light source element array 133 in which twenty two light source elements are disposed. Eleven light source elements in the light source element array 133 may be matched to the first lens array 222a of the first inner lens portion 200a, and eleven remaining light source elements may be matched to the second lens array 222b of the second inner lens portion 200b. In this case, the first lens array 222a and the second lens array 222b may include eleven sub-lenses 223, respectively, and may be matched 1:1 with twenty two light source elements provided in the light source element array 133.

The illustrated embodiment is only one example among various embodiments of the present disclosure, and the number of the plurality of light source elements 130 and the plurality of lenses 220 is not limited to an embodiment illustrated. The number of the plurality of light source elements 130 may be changed in various manners, and the number of sub-lenses 223 provided in the first lens array 222a and the second lens array 222b may be determined, depending on the number of light source elements provided in the light source element array 133.

When the first inner lens portion 200a and the second inner lens portion 200b are implemented to have a symmetrical shape, since the first lens array 222a and the second lens array 222b may have substantially the same shape, the number of light source elements provided in the light source element array 133 may be an even number.

Referring to FIGS. 6 and 7, a lens array 222 may include a plurality of sub-lenses 223 that may be integrally connected.

The lens array 222 may be formed in a shape entirety symmetrical with respect to a central axis, but sub-lenses 224a disposed in a central portion of the plurality of sub-lenses 223 may have a symmetrical structure, and at least one sub-lenses 225 disposed in a lateral outer side (edge) portion may have an asymmetrical structure.

The plurality of sub-lenses 223 may include a plurality of symmetrical sub-lenses 224a disposed in a central portion of the lens array 222. The lens array 222 may include a symmetrical sub-lens portion 224 including the plurality of symmetrical sub-lenses 224a. The plurality of sub-lenses 223 may further include at least one asymmetrical sub-lens 225 respectively disposed at both sides of the symmetrical sub-lens portion 224 including the plurality of symmetrical sub-lenses 224a.

The plurality of symmetrical sub-lenses 224a may have symmetrical shapes based on a first virtual straight line VL1 connecting a vertex V of an incident surface and a vertex V of an exit surface. For example, the plurality of symmetrical sub-lenses 224a may have rotational symmetry based on the first straight line VL1. For example, in the plurality of symmetrical sub-lenses 224a, the first straight line VL1 may correspond to a center line CL.

The plurality of asymmetrical sub-lenses 225 may have shapes that may have asymmetrical shapes at both sides based on a second virtual straight line VL2 connecting a vertex V of an incident surface and a vertex V of an exit surface. For example, each of the plurality of asymmetrical sub-lenses 225 may have different sizes, areas, and/or shapes of a portion at one side in a horizontal direction and a portion at the other side in the horizontal direction, based on the second straight line VL2. For example, the plurality of asymmetrical sub-lenses 225 may have shapes in which the center line CL is offset from the second straight line VL2.

In this case, the center line CL may be defined as a line passing through a center in a horizontal direction (e.g., Y-axis direction) of each of the plurality of symmetrical sub-lenses 224a and each of the plurality of asymmetrical sub-lenses 225, based on a plan view (e.g., view viewed from the Z-axis direction) of the lens array 222, and may be parallel to the first straight line VL1 and the second straight line VL2. In addition, the first straight line VL1 and the second straight line VL2 may pass through an optical center of a lens as an optical center line of the lens, respectively.

The plurality of asymmetrical sub-lenses 225 may be provided at least one at both sides of the plurality of symmetrical sub-lenses 224a. The plurality of asymmetrical sub-lenses 225 may be provided two or more at both sides of the plurality of symmetrical sub-lenses 224a, but are not limited thereto, and may be variously changed, depending on a size, a type, a specification, or the like of a lamp 1.

According to an embodiment illustrated, the plurality of asymmetrical sub-lenses 225 may be provided two at both sides of the plurality of symmetrical sub-lenses 224a. For example, the plurality of asymmetrical sub-lenses 225 may include two first asymmetrical sub-lenses 225a each connected to both sides of the plurality of symmetrical sub-lenses 224a (i.e., connected to both sides of the symmetrical sub-lens portion 224) in a horizontal direction, and two second asymmetrical sub-lenses 225b connected to each of the two first asymmetrical sub-lenses 225a (i.e., connected to the respective outer side of the first asymmetrical sub-lenses 225a).

According to an embodiment illustrated, the plurality of symmetrical sub-lenses 224a may all be formed to have the same size, and the first asymmetrical sub-lenses 225a and the second asymmetrical sub-lenses 225b may be formed to have a larger size than the plurality of symmetrical sub-lenses 224a. In addition, the second asymmetrical sub-lenses 225b may have a larger size than the first asymmetrical sub-lenses 225a. Relative sizes of the plurality of symmetrical sub-lenses 224a and the plurality of asymmetrical sub-lenses 225(225a,225b) are not particularly limited, and may be variously changed, depending on a size, a type, a specification, or the like of the lamp 1.

The first straight line (VL1) passes through the maximum thickness point of the plurality of symmetric sub-lenses (224a), while the second straight line (VL2) passes through the maximum thickness point of either the first asymmetric sub-lens (225a) or the second asymmetric sub-lens (225b).

Additionally, the length of the first straight line (VL1), which passes through the plurality of symmetric sub-lenses (224a), is shorter than the length of the second straight line (VL2), which passes through the first asymmetric sub-lens (225a) or the second asymmetric sub-lens (225b), and the length of the second straight line (VL2), which passes through the first asymmetric sub-lens (225a), is shorter than the length of the second straight line (VL2), which passes through the second asymmetric sub-lens (225b).

the second asymmetrical sub-lens 225b may have an optical power less than an optical power of the first asymmetrical sub-lens 225a and the first asymmetrical sub-lens 225a may have an optical power less than an optical power of each of the plurality of symmetrical sub-lenses 224a.

Optical power refers to the ability of the lens to refract light, and it can be inversely proportional to the focal length of the lens.

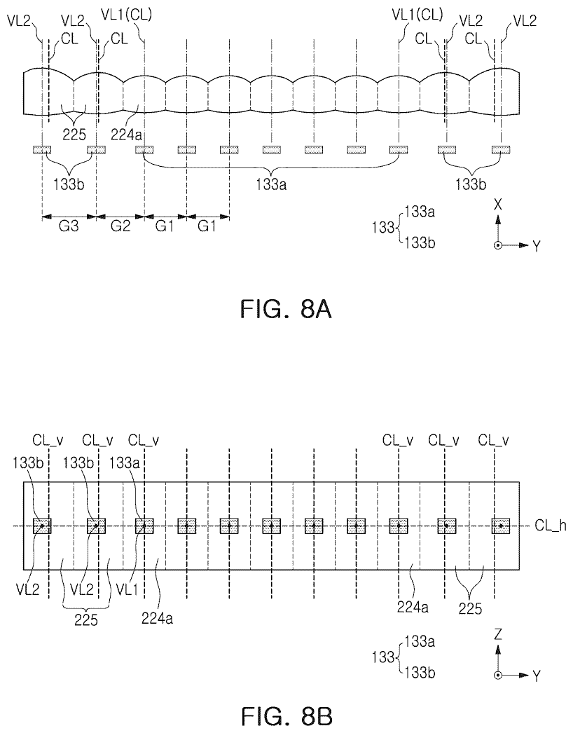

FIGS. 8A and 8B are views illustrating a layout relationship between a lens array and a light source element array of a lamp for a vehicle according to an embodiment of the present disclosure.

FIG. 8A is a view illustrating a lens array and a light source element array as viewed from above (e.g., +Z-axis direction), and FIG. 8B is a view illustrating a lens array and a light source element array as viewed in an incident surface direction (e.g., −X-axis direction).

FIG. 8A and FIG. 8B are views illustrating a configuration in which a lens array 222 and a light source element array 133 of a lamp 1 for a vehicle, as described with reference to FIGS. 1-7 , are aligned, and thus, any redundant description has been omitted hereinafter.

A lens array 222 and a light source element array 133, illustrated in FIGS. 8A and 8B, may be referred to the lens array 222 and the light source element array 133 illustrated in FIGS. 5-7 , and hereinafter, when describing FIGS. 8A and 8B, FIGS. 5-7 are referred to together.

Referring to FIGS. 8A and 8B, light source elements 133a matched or assigned to a plurality of symmetrical sub-lenses 224a of a lens array 222, among light source element arrays 133, may be disposed in alignment at a center of a lens, and light source elements 133b matched or assigned to a plurality of asymmetrical sub-lenses 225 of the lens array 222, among the light source element arrays 133, may be disposed to be offset from the center of the lens.

A plurality of light source elements 130 may be disposed in positions in which a virtual straight line (e.g., first straight line VL1 and second straight line VL2) connecting a vertex of an incident surface and a vertex of an exit surface of each of a plurality of sub-lenses 223 passes through centers of the plurality of light source elements 130.

As a result, since the plurality of symmetrical sub-lenses 224a may have a first straight line VL1 overlapping a center line CL of the lens, the light source elements 133a assigned thereto may be aligned at a center of each of the plurality of symmetrical sub-lenses 224a, whereas since the first asymmetrical sub-lens 225a and the second asymmetrical sub-lens 225b may have a second straight line VL2 offset from the center line CL of the lens, such that the light source elements 133b assigned thereto may be offset from a center of each of the first asymmetrical sub-lens 225a and the second asymmetrical sub-lens 225b. In this case, the center line CL may be referred to as the center line CL illustrated in FIG. 7.

As illustrated in FIG. 8B, when viewing the lens array 222 in a direction of an incident surface (e.g., X-axis direction), a horizontal center line CL_h and a vertical center line CL_v may be defined for each of the plurality of sub-lenses 223 of the lens array 222, and each of the plurality of sub-lenses 223 may have the same horizontal center line CL_h.

The light source elements 133a corresponding to the plurality of symmetrical sub-lenses 224a may be disposed such that centers of light emission thereof may overlap an intersection between the horizontal center line CL_h and the vertical center line CL_v.

The light source elements 133b corresponding to the plurality of asymmetrical sub-lenses 225 may be disposed such that centers of light emission thereof may be offset from the intersection between the horizontal center line CL_h and the vertical center line CL_v, but may overlap the second virtual straight line VL2 connecting the vertex of the incident surface and the vertex of the exit surface.

A position of the light source element array 133 on the substrate 110 may be determined in response to a shape of the lens array 222. According to an embodiment illustrated in FIGS. 8A and 8B, the light source elements 133a matched to the plurality of symmetrical sub-lenses 224a of the lens array 222, among the light source element array 133, may be spaced apart from each other by a first interval G1, in the same manner to each other, and the light source elements 133b matched to the plurality of asymmetrical sub-lenses 225 of the lens array 222, among the light source element array 133, may be spaced apart by an interval, different from the first interval G1.

For example, referring to FIG. 8A and FIG. 7 together, a light source element 133b aligned with a first asymmetrical lens 225a may be spaced apart from a light source element 133a aligned with a symmetrical sub-lens 224a disposed at an outermost side by a second interval G2, greater than the first interval G1, and a light source element 133b aligned with a second asymmetrical lens 225b may be spaced apart from a light source element 133b aligned with a first asymmetrical lens 255a by a third interval G3, greater than the second interval G2. The first interval G1, the second interval G2, and the third interval G3 refer to distances between centers of adjacent light source elements.

The illustrated embodiment is illustrative, and the lens array 222 may have a shape in which the second interval G2 and the third interval G3 are the same, or may have a shape in which the second interval G2 and the third interval G3 are smaller than the first interval G1.

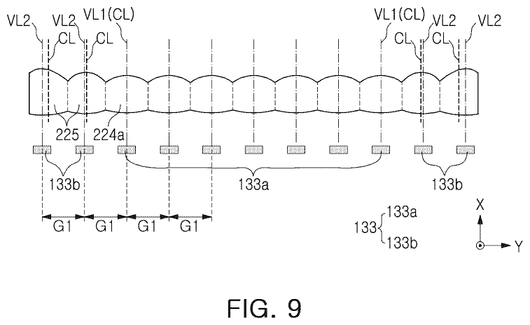

FIG. 9 is a view illustrating a layout relationship between a lens array and a light source element array of a lamp for a vehicle according to an embodiment of the present disclosure.

FIG. 9 illustrates an embodiment in which, unlike FIGS. 8A and 8B, light source elements constituting a light source element array 133 may be disposed at the same interval, and accordingly, a distance between optical centers of each of a plurality of sub-lenses 224a and 225 constituting a lens array 222 may be the same, and thus, any duplicate description has been omitted.

Referring to FIG. 9, light source elements provided in a light source element array 133 may be disposed to be spaced apart from each other by a first interval G1, in the same manner to each other, and a lens array 222 may be formed in a shape in which an optical element (133a and 133b) is aligned to an optical center line (VL1 and VL2) corresponding to the light source element array 133, spaced apart by the first interval G1. Therefore, a distance between first straight lines VL1 of symmetrical lenses 244 adjacent to each other, a distance between a first straight line VL1 of a symmetrical lens and a second straight line VL2 of an asymmetrical lens, adjacent to each other, and a distance between second straight lines VL2 of asymmetrical lenses adjacent to each other become equal to the first interval G1 between optical elements 133a and 133b adjacent to each other.

According to an embodiment of the present disclosure, it is possible to implement slimming of a lamp for a vehicle including an IFS function.

While example embodiments have been illustrated and described above, it should be apparent to those having ordinary skill in the art that modifications and variations could be made without departing from the scope of the present disclosure as defined by the appended claims.

What is claimed is:

1. A lamp for a vehicle comprising:
a light source portion including a plurality of light source elements; and
an inner lens portion including a plurality of lenses through which light from the plurality of light source elements passes,
wherein the plurality of lenses includes a lens array having a plurality of light-collecting lenses, and wherein the plurality of light-collecting lenses includes at least one asymmetrical sub-lens having an asymmetrical shape.

2. The lamp of claim 1, wherein the plurality of light-collecting lenses comprises a symmetrical sub-lens portion including a plurality of symmetrical sub-lenses, and
wherein the at least one asymmetrical sub-lens is disposed on a side of the symmetrical sub-lens portion.

3. The lamp of claim 2, wherein each of the plurality of symmetrical sub-lenses has a shape symmetrical about a first virtual straight line connecting a vertex of an incident surface and a vertex of an exit surface, and has a center overlapping the first virtual straight line.

4. The lamp of claim 3, wherein among the plurality of light source elements, a light source element corresponding to the plurality of symmetrical sub-lenses is disposed such that the first virtual straight line passes through a center of the light source element corresponding to the plurality of symmetrical sub-lenses.

5. The lamp of claim 2, wherein the at least one asymmetrical sub-lens has a shape that is asymmetrical based on a second virtual straight line connecting a vertex of an incident surface and a vertex of an exit surface, and
has a center offset from the second virtual straight line.

6. The lamp of claim 5, wherein among the plurality of light source elements, a light source element corresponding to the at least one asymmetrical sub-lens is disposed such that the second virtual straight line passes through a center of the light source element corresponding to the at least one asymmetrical sub-lens.

7. The lamp of claim 2, wherein each of the plurality of symmetrical sub-lenses is formed to have a same size, and
the at least one asymmetrical sub-lens is formed to have a size greater than a size of each of the plurality of symmetrical sub-lenses.

8. The lamp of claim 2, wherein the at least one asymmetrical sub-lens comprises:
first asymmetrical sub-lenses each connected to each of both sides of the symmetrical sub-lens portion; and
second asymmetrical sub-lenses each connected to each of the first asymmetrical sub-lenses.

9. The lamp of claim 8, wherein each of the second asymmetrical sub-lenses is formed to have a size greater than a size of each of the first asymmetrical sub-lenses.

10. The lamp of claim 9, wherein the second asymmetrical sub-lenses of a greater size are connected on a respective outer side of the first asymmetrical sub-lenses of a smaller size.

11. The lamp of claim 1, further comprising:
an outer lens portion disposed in front of the inner lens portion; and
a bezel to which the outer lens portion and the light source portion are coupled,
wherein the light source portion further includes a substrate coupled to the bezel, wherein the plurality of light source elements is disposed on a front surface of the substrate.

12. The lamp of claim 11, wherein the inner lens portion is coupled to the front surface of the substrate, such that the plurality of lenses faces the plurality of light source elements.

13. The lamp of claim 11, further comprising a bulkhead member disposed between the outer lens portion and the inner lens portion,
wherein the bulkhead member separates and divides a space between the inner lens portion and the outer lens portion into two or more spaces.

14. The lamp of claim 13, wherein the inner lens portion comprises a first inner lens portion and a second inner lens portion disposed with a predetermined gap therebetween, and
the lens array comprises a first lens array provided in the first inner lens portion, and a second lens array provided in the second inner lens portion.

15. The lamp of claim 14, wherein the bulkhead member comprises a central bulkhead inserted into the predetermined gap between the first inner lens portion and the second inner lens portion to block a space between the first lens array and the second lens array.

16. The lamp of claim 14, wherein the first lens array and the second lens array have a same shape, and
the first inner lens portion and the second inner lens portion are symmetrical with respect to the predetermined gap.

17. The lamp of claim 16, wherein the plurality of lenses further comprise:
a first lens provided in the first inner lens portion and spaced apart from one side of the first lens array, and
a second lens provided in the second inner lens portion and spaced apart from one side of the second lens array.

18. A lamp for a vehicle comprising:
a light source portion including a plurality of light source elements spaced apart at equal intervals; and
an inner lens portion including a plurality of lenses through which light from the plurality of light source elements passes,
wherein the plurality of lenses includes a lens array having a plurality of light-collecting lenses,
the plurality of light-collecting lenses includes a plurality of symmetrical sub-lenses having a symmetrical shape and at least one asymmetrical sub-lens having an asymmetrical shape provided on a side portion of a symmetrical sub-lens portion including the plurality of symmetrical sub-lenses, and
an optical center of each of the plurality of light-collecting lenses is formed to be aligned with a center of each of the plurality of light source elements.

19. The lamp of claim 18, wherein the optical center overlaps a virtual straight line connecting a vertex of an incident surface and a vertex of an exit surface of each of the plurality of light-collecting lenses, and
the asymmetrical sub-lens has a shape asymmetrical at both sides, based on the virtual straight line.

20. A vehicle comprising a lamp,
wherein the lamp includes:
a light source portion including a plurality of light source elements; and
an inner lens portion including a plurality of lenses through which light from the plurality of light source elements passes,
wherein the plurality of lenses includes a lens array having a structure in which a plurality of sub-lenses is connected, and disposed to face at least a portion of the plurality of light source elements,
wherein at least one asymmetrical sub-lens having an asymmetrical shape is provided on a side portion of the lens array, wherein the plurality of sub-lenses comprises a symmetrical sub-lens portion including a plurality of symmetrical sub-lenses forming a center of the lens array, and
wherein the at least one asymmetrical sub-lens is disposed at both sides of the symmetrical sub-lens portion, respectively.
